(19) United States
(12) Patent Application Publication
(10) Pub. No.: US 2011/0094683 A1
(43) Pub. Date: Apr. 28, 2011

(54) RF FEED STRUCTURE FOR PLASMA PROCESSING

(75) Inventors: ZHIGANG CHEN, Campbell, CA (US); SHAHID RAUF, Pleasanton, CA (US); KENNETH S. COLLINS, San Jose, CA (US); MARTIN JEFF SALINAS, San Jose, CA (US); SAMER BANNA, San Jose, CA (US); VALENTIN N. TODOROW, Palo Alto, CA (US)

(73) Assignee: APPLIED MATERIALS, INC., Santa Clara, CA (US)

(21) Appl. No.: 12/821,626

(22) Filed: Jun. 23, 2010

Related U.S. Application Data
(60) Provisional application No. 61/254,838, filed on Oct. 26, 2009.

(51) Int. Cl. H05H 1/24; H01P 5/12

(52) U.S. Cl. 156/345.35; 333/100

(57) ABSTRACT

Apparatus for plasma processing are provided. In some embodiments, an RF feed structure includes a first RF feed to couple RF power to a plurality of symmetrically arranged stacked first RF coil elements; a second RF feed coaxially disposed about the first RF feed and electrically insulated therefrom, the second RF feed to couple RF power to a plurality of symmetrically arranged stacked second RF coil elements coaxially disposed with respect to the first RF coil elements. In some embodiments, a plasma processing apparatus includes a first RF coil; a second RF coil coaxially disposed with respect to the first RF coil; a first RF feed coupled to the first RF coil to provide RF power thereto; and a second RF feed coaxially disposed with respect to the first RF feed and electrically insulated therefrom, the second RF feed coupled to the second RF coil to provide RF power thereto.

### CROSS-REFERENCE TO RELATED APPLICATIONS

This application claims benefit of U.S. provisional patent application Ser. No. 61/254,838, filed Oct. 26, 2009, which is herein incorporated by reference in its entirety.

### FIELD

Embodiments of the present invention generally relate to plasma processing equipment.

### BACKGROUND

Inductively coupled plasma (ICP) process reactors generally form plasmas by inducing current in a process gas disposed within the process chamber via one or more inductive coils disposed outside of the process chamber. The inductive coils may be disposed externally and separated electrically from the chamber by, for example, a dielectric lid. When radio frequency (RF) current is fed to the inductive coils via an RF feed structure from an RF power supply, an inductively coupled plasma can be formed inside the chamber from an electric field generated by the inductive coils.

The inventors have discovered that due to magnetic field asymmetries caused by an asymmetric shape of the RF feed structure, the electric field generated by the inductive coils is asymmetric, causing a plasma generated by the inductive coils to have an asymmetric distribution.

Accordingly, the inventors have devised an improved RF feed structure to overcome magnetic and electric field asymmetries.

### SUMMARY

Apparatus for plasma processing are provided herein. In some embodiments, an RF feed structure includes a first RF feed to couple RF power to a plurality of symmetrically arranged stacked first RF coil elements; a second RF feed coaxially disposed about the first RF feed and electrically insulated therefrom, the second RF feed to couple RF power to a plurality of symmetrically arranged stacked second RF coil elements coaxially disposed with respect to the first RF coil elements.

In some embodiments, a plasma processing apparatus includes a first RF coil; a second RF coil coaxially disposed with respect to the first RF coil; a first RF feed coupled to the first RF coil to provide RF power thereto; and a second RF feed coaxially disposed with respect to the first RF feed and electrically insulated therefrom, the second RF feed coupled to the second RF coil to provide RF power thereto. Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic side view of an inductively coupled plasma reactor in accordance with some embodiments of the present invention.

FIGS. 2A-B depict an RF feed structure in accordance with some embodiments of the present invention.

FIGS. 3A-B depict schematic top views of an inductively coupled plasma apparatus in accordance with some embodiments of the present invention.

FIG. 4 depicts a schematic side view of an inductively coupled plasma reactor in accordance with some embodiments of the present invention.

FIGS. 5A-D illustratively depict graphs of electric fields generated using conventional apparatus and an embodiment of the inventive apparatus disclosed herein.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation unless incompatible therewith or explicitly stated to the opposite.

### DETAILED DESCRIPTION

Apparatus for plasma processing are provided herein. In some embodiments, the inventive apparatus includes an RF feed structure for coupling RF power to inductive RF coils. The inventive RF feed structure advantageously reduces magnetic field asymmetries proximate the inductive RF coils such that a electric field generated by the RF coils is symmetric, or more symmetric as compared to conventional RF feeds, and accordingly facilitates the formation of a plasma having a symmetric, or more symmetric, electric field distribution.

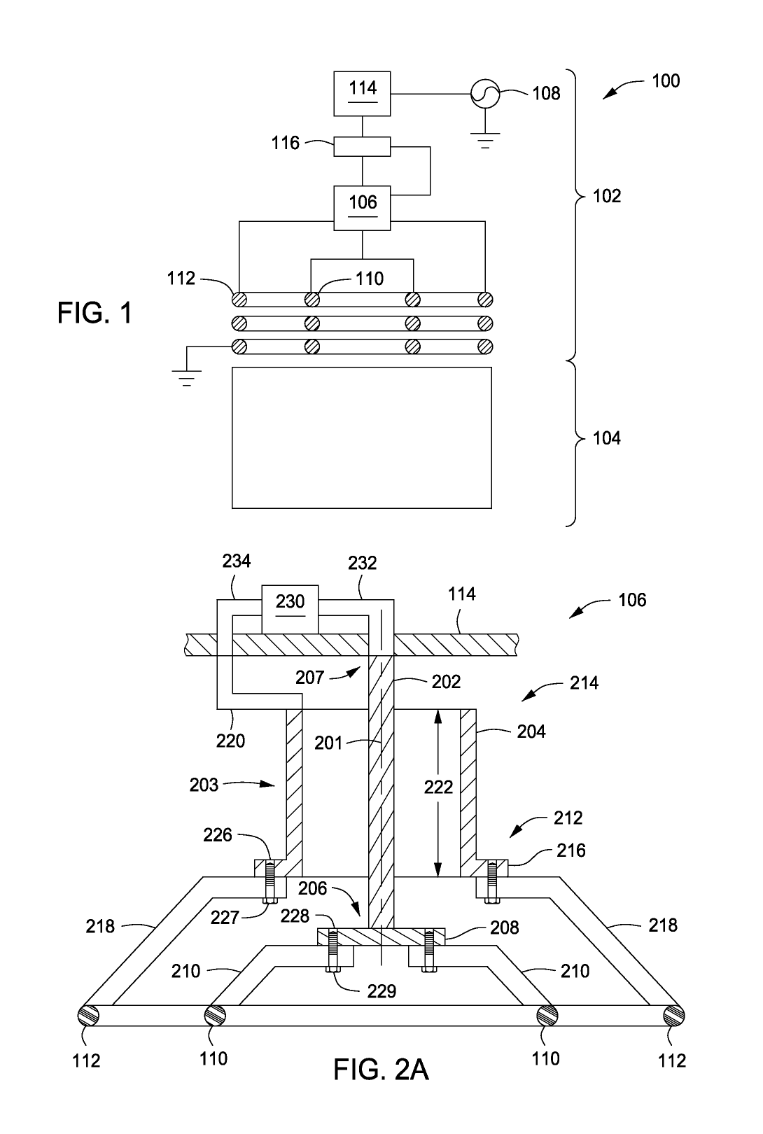

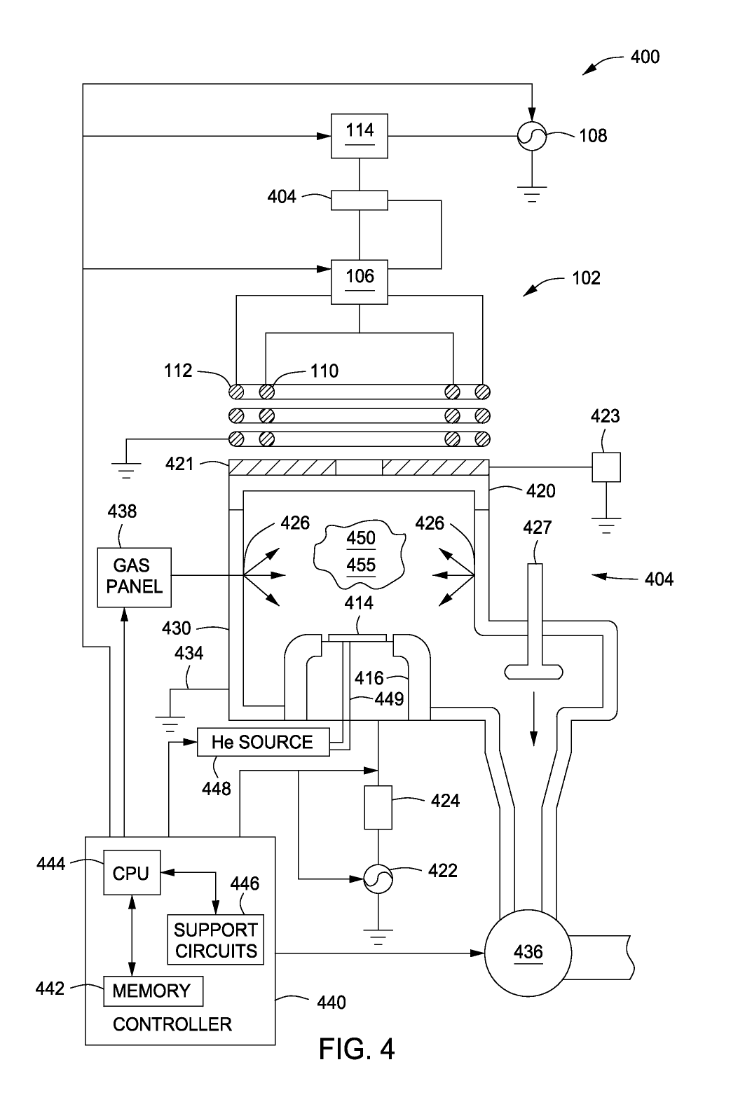

FIG. 1 depicts an exemplary and simplified schematic side view of an inductively coupled plasma reactor 100 in accordance with some embodiments of the present invention. A more detailed view of an exemplary plasma reactor suitable for use with embodiments of the present invention is depicted in FIG. 4. The plasma reactor includes an inductively coupled plasma apparatus 102 disposed atop a process chamber 104. The inductively coupled plasma apparatus includes an RF feed structure 106 for coupling an RF power supply 108 to a plurality of RF coils, e.g., a first RF coil 110 and a second RF coil 112. The plurality of RF coils are coaxially disposed proximate the process chamber 104 (for example, above the process chamber) and are configured to inductively couple RF power into the process chamber 104 to form a plasma from process gases provided within the process chamber 104.

The RF power supply 108 is coupled to the RF feed structure 106 via a match network 114. A power divider 116 may be provided to adjust the RF power respectively delivered to the first and second RF coils 110, 112. The power divider 116 may coupled between the match network 114 and the RF feed structure 106. Alternatively, the power divider may be a part of the match network 114, in which case the match network will have two outputs coupled to the RF feed structure 106—one corresponding to each RF coil 110, 112. The power divider is discussed in more detail below in accordance with the embodiments illustrated in FIG. 4.

The RF feed structure 106 couples the RF current from the power divider 116 (or the match network 114 where the power divider is incorporated therein) to the respective RF coils. The RF feed structure 106 is configured to provide the RF current to the RF coils in a symmetric manner, such that the RF current is coupled to each coil in a geometrically symmetric configuration with respect to a central axis of the RF coils.

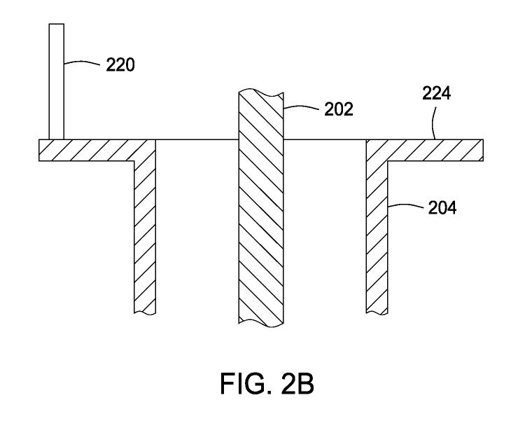

For example, FIG. 2A-B depicts the RF feed structure 106 in accordance with some embodiments of the present invention. As depicted in FIG. 2A, the RF feed structure 106 may include a first RF feed 202 and a second RF feed 204 coaxially disposed with respect to the first RF feed 202. The first RF feed 202 is electrically insulated from the second RF feed 204. In some embodiments, the RF feed structure 106 may be substantially linear, having a central axis 201. As used herein, substantially linear refers to the geometry along the axial length of the RF feed structure and excludes any flanges or other features that may be formed near the ends of the RF feed structure elements, for example, to facilitate coupling to either the output of the match network or power divider or to the input of the RF coils. In some embodiments, and as illustrated, the first and second RF feeds 202, 204 may be substantially linear, with the second RF feed 204 coaxially disposed about the first RF feed 202. The first and second RF feeds 202, 204 may be formed of any suitable conducting material for coupling RF power to RF coils. Exemplary conducting materials may include copper, aluminum, or the like. The first and second RF feeds 202, 204 may be electrically insulated by one or more insulating materials, such as air, a fluoropolymer (such as Teflon®), polyethylene, or the like.

The first RF feed 202 and the second RF feed 204 are each coupled to different ones of the first or second RF coils 110, 112. In some embodiments, the first RF feed 202 may be coupled to the first RF coil 110. The first RF feed 202 may include one or more of a conductive wire, cable, bar, tube, or other suitable conductive element for coupling RF power. In some embodiments, the cross section of the first RF feed 202 may be substantially circular. The first RF feed 202 may include a first end 206 and a second end 207. The second end 207 may be coupled to the match network 114 (as shown) or to a power divider (as shown in FIG. 1). For example, as depicted in FIG. 2A, the match network 114 may include a power divider 230 having two outputs 232, 234 for providing the divided RF current to the RF coils via the RF feed structure. The second end 207 of the first RF feed 202 is coupled to one of the two outputs of the match network 114 (e.g., output 232 depicted in FIG. 2A).

The first end 206 of the first RF feed 202 may be coupled to the first RF coil 110. The first end 206 of the first RF feed 202 may be coupled to the first RF coil 110 directly, or via some intervening supporting structure (a base 208 is shown in FIG. 2A). The base 208 may be circular or some other shape and may include symmetrically arranged coupling points for coupling the first RF coil 110 thereto. For example, in FIG. 2A, two terminals 228 are shown disposed on opposite sides of the base 208 for coupling to two portions of the first RF coil via, for example, screws 229 (although any suitable coupling may be provided, such as clamps, welding, or the like).

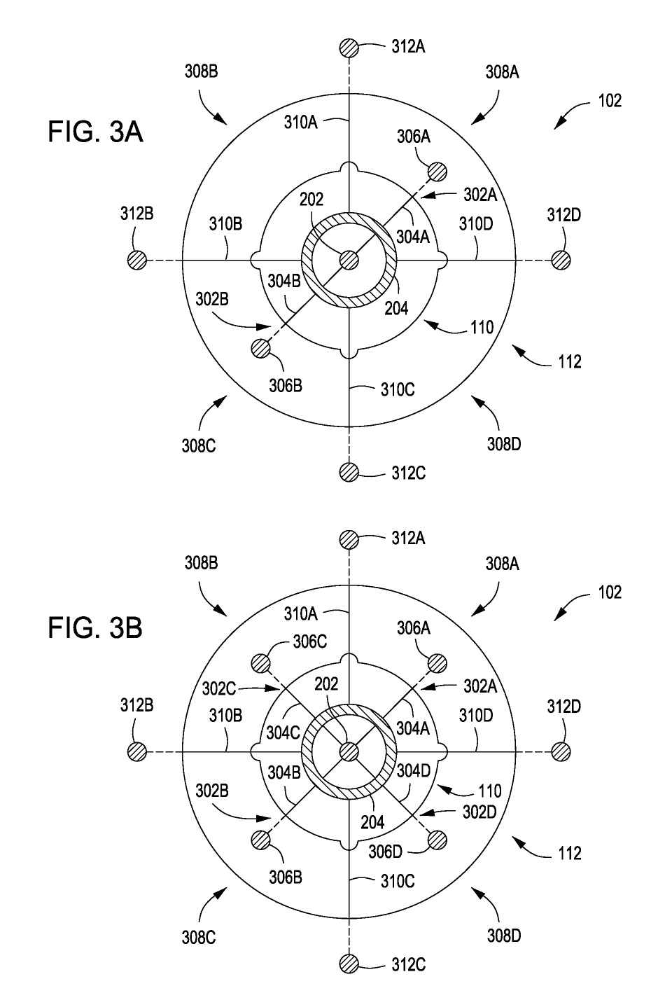

In some embodiments, and as discussed further below in relation to FIGS. 3A-B, the first RF coil 110 (and/or the second RF coil 112) may comprise a plurality of interlineated and symmetrically arranged stacked coils (e.g., two or more). For example, the first RF coil 110 may comprise a plurality of conductors that are wound into a coil, with each conductor occupying the same cylindrical plane. Each interlineated, stacked coil may further have a leg 210 extending inwardly therefrom towards a central axis of the coil. In some embodiments, each leg extends radially inward from the coil towards the central axis of the coil. Each leg 210 may be symmetrically arranged about the base 208 and/or the first RF feed 202 with respect to each other (for example two legs 180 degrees apart, three legs 120 degrees apart, four legs 90 degrees apart, and the like). In some embodiments, each leg 210 may be a portion of a respective RF coil conductor that extends inward to make electrical contact with the first RF feed 202. In some embodiments, the first RF coil 110 may include a plurality of conductors each having a leg 210 that extends inwardly from the coil to couple to the base 208 at respective ones of the symmetrically arranged coupling points (e.g., terminals 228).

The second RF feed 204 may be a conductive tube 203 coaxially disposed about the first RF feed 202. The second RF feed 204 may further include a first end 212 proximate the first and second RF coils 110, 112 and a second end 214 opposite the first end 212. In some embodiments, the second RF coil 112 may be coupled to the second RF feed 204 at the first end 212 via a flange 216, or alternatively, directly to the second RF feed 204 (not shown). The flange 216 may be circular or other in shape and is coaxially disposed about the second RF feed 204. The flange 216 may further include symmetrically arranged coupling points to couple the second RF coil 112 thereto. For example, in FIG. 2A, two terminals 226 are shown disposed on opposite sides of the second RF feed 204 for coupling to two portions of the second RF coil 112 via, for example, screws 227 (although any suitable coupling may be provided, such as described above with respect to terminals 228).

Like the first RF coil 110, and also discussed further below in relation to FIGS. 3A-B, the second RF coil 112 may comprise a plurality of interlineated and symmetrically arranged stacked coils. Each stacked coil may have a leg 218 extending therefrom for coupling to the flange 216 at a respective one of the symmetrically arranged coupling points. Accordingly, each leg 218 may be symmetrically arranged about the flange 216 and/or the second RF feed 204.

The second end 214 of the second RF feed 204 may be coupled to the match network 114 (as shown) or to a power divider (as shown in FIG. 1). For example, as depicted in FIG. 2A, the match network 114 includes a power divider 230 having two outputs 232, 234. The second end 214 of the second RF feed 204 may be coupled to one of the two outputs of the match network 114 (e.g., 234). The second end 214 of the second RF feed 204 may be coupled to the match network 114 via a conductive element 220 (such as a conductive strap). In some embodiments, the first and second ends 212, 214 of the second RF feed 204 may be separated by a length 222 sufficient to limit the effects of any magnetic field asymmetry that may be caused by the conductive element 220. The required length may depend upon the RF power intended to be used in the process chamber 104, with more power supplied requiring a greater length. In some embodiments, the length 222 may be between about 2 to about 8 inches (about 5 to about 20 cm). In some embodiments, the length is such that a magnetic field formed by flowing RF current through the first and second RF feeds has substantially no effect on the symmetry of an electric field formed by flowing RF current through the first and second RF coils 110, 112.

In some embodiments, and as illustrated in FIG. 2B, a disk 224 may be coupled to the second RF feed 204 proximate the second end 214 thereof. The conductive element 220, or other suitable connector, may be used to couple the disk 224 to the output of the match network (or the power divider). The disk 224 may be fabricated from the same kinds of materials as the second RF feed 204 and may be the same or different material as the second RF feed 204. The disk 224 may be an integral part of the second RF feed 204 (as shown), or alternatively may be coupled to the second RF feed 204, by any suitable means that provides a robust electrical connection therebetween, including but not limited to bolting, welding, press fit of a lip or extension of the disk about the second RF feed 204, or the like. The disk 224 may be coaxially disposed about the second RF feed 204. The disk 224 may be coupled to the match network 114 or to a power divider in any suitable manner, such as via a conductive strap or the like. The disk 224 advantageously provides an electric shield that lessens or eliminates any magnetic field asymmetry due to the offset outputs from the match network 114 (or from the power divider). Accordingly, when a disk 224 is utilized for coupling RF power, the length 222 of the second RF feed 204 may be shorter than when the conductive element 220 is coupled directly to the second RF feed 204. In such embodiments, the length 222 may be between about 1 to about 6 inches (about 2 to about 15 cm).

FIGS. 3A-B depict a schematic top down view of the inductively coupled plasma apparatus 102 in accordance with some embodiments of the present invention. As discussed above, the first and second RF coils 110, 112 need not be a singular continuous coil, and may each be a plurality (e.g., two or more) of interlineated and symmetrically arranged stacked coil elements. Further, the second RF coil 112 may be coaxially disposed with respect to the first RF coil 112. In some embodiments, the second RF coil 112 is coaxially disposed about the first RF coil 112 as shown in FIGS. 3A-B.

In some embodiments, and illustrated in FIG. 3A, the first RF coil 110 may include two interlineated and symmetrically arranged stacked first RF coil elements 302A, 302B and the second RF coil 112 includes four interlineated and symmetrically arranged stacked second RF coil elements 308A, 308B, 308C, and 308D. The first RF coil elements 302A, 302B may further include legs 304A, 304B extending inwardly therefrom and coupled to the first RF feed 202. The legs 304A, 304B are substantially equivalent to the legs 210 discussed above. The legs 304A, 304B are arranged symmetrically about the first RF feed 202 (e.g., they are opposing each other). Typically, RF current may flow from the first RF feed 202 through the legs 302A, 302B into the first RF coil elements 304A, 304B and ultimately to grounding posts 306A, 306B coupled respectively to the terminal ends of the first RF coil elements 302A, 302B. To preserve symmetry, for example, such as electric field symmetry in the first and second RF coils 110, 112, the ground posts 306A, 306B may be disposed about the first RF feed structure 202 in a substantially similar symmetrical orientation as the legs 302A, 302B. For example, and as illustrated in FIG. 3A, the grounding posts 306A, 306B are disposed in-line with the legs 302A, 302B.

Similar to the first RF coil elements, the second RF coil elements 308A, 308B, 308C, and 308D may further include legs 310A, 310B, 310C, and 310D extending therefrom and coupled to the second RF feed 204. The legs 310A, 310B, 310C, and 310D are substantially equivalent to the legs 218 discussed above. The legs 310A, 310B, 310C, and 310D are arranged symmetrically about the second RF feed 204. Typically, RF current may flow from the second RF feed 204 through the legs 310A, 310B, 310C, and 310D into the second RF coil elements 308A, 308B, 308C, and 308D respectively and ultimately to grounding posts 312A, 312B, 312C, and 312D coupled respectively to the terminal ends of the second RF coil elements 308A, 308B, 308C, and 308D. To preserve symmetry, for example, such as electric field symmetry in the first and second RF coils 110, 112, the ground posts 312A, 312B, 312C, and 312D may be disposed about the first RF feed structure 202 in a substantially similar symmetrical orientation as the legs 310A, 310B, 310C, and 310D. For example, and as illustrated in FIG. 3A, the grounding posts 312A, 312B, 312C, and 312D are disposed in-line with the legs 310A, 310B, 310C, and 310D, respectively.

In some embodiments, and as illustrated in FIG. 3A, the legs/grounding posts of the first RF coil 110 may oriented at an angle with respect to the legs/grounding posts of the second RF coil 112. However, this is merely exemplary and it is contemplated that any symmetrical orientation may be utilized, such as the legs/ground posts of the first RF coil 110 disposed in-line with the legs/grounding posts of the second RF coil 112.

In some embodiments, and illustrated in FIG. 3B, the first RF coil 110 may include four interlineated and symmetrically arranged stacked first RF coil elements 302A, 302B, 302C, and 302D. Like the first RF coil elements 302A, 302B, the additional first RF coil elements 302C, 302D may further include legs 304C, 304D extending therefrom and coupled to the first RF feed 202. The legs 304C, 304D are substantially equivalent to the legs 210 discussed above. The legs 304A, 304B, 304C, and 304D are arranged symmetrically about the first RF feed 202. Like the first RF coil elements 302A, 302B, the first RF coil elements 302C, 302D terminate at grounding posts 306C, 306D disposed in-line with legs 304C, 304D. To preserve symmetry, for example, such as electric field symmetry in the first and second RF coils 110, 112, the ground posts 306A, 306B, 306C, and 306D may be disposed about the first RF feed structure 202 in a substantially similar symmetrical orientation as the legs 302A, 302B, 302C, and 302D. For example, and as illustrated in FIG. 3B, the grounding posts 306A, 306B, 306C, and 306D are disposed in-line with the legs 302A, 302B, 302C, and 302D, respectively. The second RF coil elements 308A, 308B, 308C, and 308D and all components (e.g., legs/grounding posts) thereof are the same in FIG. 3B as in FIG. 3A and described above.

In some embodiments, and as illustrated in FIG. 3B, the legs/grounding posts of the first RF coil 110 are oriented at an angle with respect to the legs/grounding posts of the second RF coil 112. However, this is merely exemplary and it is contemplated that any symmetrical orientation may be utilized, such as the legs/ground posts of the first RF coil 110 disposed in-line with the legs/grounding posts of the second RF coil 112.

Although described above using examples of two or four stacked elements in each coil, it is contemplated that any number of coil elements can be utilized with either or both of the first and second RF coils 110, 112, such as three, six, or any suitable number and arrangement that preserves symmetry about the first and second RF feeds 202, 204. For example, three coil elements may be provided in a coil each rotated 120 degrees with respect to an adjacent coil element.

FIG. 4 depicts a schematic side view of an inductively coupled plasma reactor 400 in accordance with some embodiments of the present invention. The reactor 400 may be utilized alone or, as a processing module of an integrated semiconductor substrate processing system, or cluster tool, such as a CENTURA® integrated semiconductor wafer processing system, available from Applied Materials, Inc. of Santa Clara, Calif. Examples of suitable plasma reactors that may advantageously benefit from modification in accordance with embodiments of the present invention include inductively coupled plasma etch reactors such as the DPS® line of semiconductor equipment (such as the DPS®, DPS® II, DPS® AE, DPS® G3 poly etcher, DPS® G5, or the like) also available from Applied Materials, Inc. The above listing of semiconductor equipment is illustrative only, and other etch reactors, and non-etch equipment (such as CVD reactors, or other semiconductor processing equipment) may also be suitably modified in accordance with the present teachings. Other examples of suitable inductively coupled plasma reactors that may be used in accordance with the present invention includes those described in U.S. Patent Application Ser. No. 61/254,833, filed on Oct. 26, 2009, by V. N. Todorow, et al., and entitled “INDUCTIVELY COUPLED PLASMA APPARATUS WITH PHASE CONTROL,” and U.S. Patent Application Ser. No. 61/254,837, filed on Oct. 26, 2009, by S. Banna, et al., and entitled “DUAL MODE INDUCTIVELY COUPLED PLASMA REACTOR WITH ADJUSTABLE PHASE COIL ASSEMBLY,” each of which are hereby incorporated by reference in their entireties.

The reactor 400 generally includes a process chamber 404 having a conductive body (wall) 430 and a dielectric lid 420 (that together define a processing volume), a substrate support pedestal 416 disposed within the processing volume, the inductively coupled plasma apparatus 102, and a controller 440. The wall 430 is typically coupled to an electrical ground 434. In some embodiments, the support pedestal (cathode) 416 may be coupled, through a matching network 424, to a biasing power source 422. The biasing source 422 may illustratively be a source of up to 1000 W at a frequency of approximately 13.56 MHz that is capable of producing either continuous or pulsed power, although other frequencies and powers may be provided as desired for particular applications. In other embodiments, the source 422 may be a DC or pulsed DC source.

In some embodiments, the dielectric lid 420 may be substantially flat. Other modifications of the chamber 104 may have other types of lids such as, for example, a dome-shaped lid or other shapes. The inductively coupled plasma apparatus 102 is typically disposed above the lid 420 and is configured to inductively coupling RF power into the process chamber 404. The inductively coupled plasma apparatus 102 includes the first and second RF coils 110, 112 as discussed above, disposed above the dielectric lid 420. The relative position, ratio of diameters of each coil, and/or the number of turns in each coil can each be adjusted as desired to control, for example, the profile or density of the plasma being formed. Each of the first and second RF coils 110, 112 is coupled, through the matching network 114 via the RF feed structure, to the RF power supply 108. The RF power supply 108 may illustratively be capable of producing up to 4000 W at a tunable frequency in a range from 50 kHz to 13.56 MHz, although other frequencies and powers may be provided as desired for particular applications.

In some embodiments, a power divider, such as a dividing capacitor, may be provided between the RF feed structure 106 to control the relative quantity of RF power provided by the RF power supply 108 to the respective first and second RF coils. For example, as shown in FIG. 4, a power divider 404 may be disposed in the line coupling the RF feed structure 106 to the RF power supply 108 for controlling the amount of RF power provided to each coil (thereby facilitating control of plasma characteristics in zones corresponding to the first and second RF coils).

Optionally, one or more electrodes (not shown) may be electrically coupled to one of the first or second RF coils 110, 112, e.g., an inner coil, such as the first RF coil 110. The one or more electrodes may be two electrodes disposed between the first RF coil 110 and the second RF coil 112 and proximate the dielectric lid 420. Each electrode may be electrically coupled to either the first RF coil 110 or the second RF coil 112, and RF power may be provided to the one or more electrodes via the RF power supply 108 via the inductive coil to which they are coupled (e.g., the first RF coil 110 or the second RF coil 112).

In some embodiments, the one or more electrodes may be movably coupled to one of the one or more inductive coils to facilitate the relative positioning of the one or more electrodes with respect to the dielectric lid 420 and/or with respect to each other. For example, one or more positioning mechanisms may be coupled to one or more of the electrodes to control the position thereof. The positioning mechanisms may be any suitable device, manual or automated, that can facilitate the positioning of the one or more electrodes as desired, such as devices including lead screws, linear bearings, stepper motors, wedges, or the like. The electrical connectors coupling the one or more electrodes to a particular inductive coil may be flexible to facilitate such relative movement. For example, in some embodiments, the electrical connector may include one or more flexible mechanisms, such as a braided wire or other conductor. A more detailed description of the electrodes and their utilization in plasma processing apparatus can be found in U.S. patent application Ser. No. 12/182,342, filed Jul. 30, 2008, titled “Field Enhanced Inductively Coupled Plasma (FE-ICP) Reactor,” which is herein incorporated by reference in its entirety.

A heater element 421 may be disposed atop the dielectric lid 420 to facilitate heating the interior of the process chamber 104. The heater element 421 may be disposed between the dielectric lid 420 and the first and second RF coils 110, 112. In some embodiments. the heater element 421 may include a resistive heating element and may be coupled to a power supply 423, such as an AC power supply, configured to provide sufficient energy to control the temperature of the heater element 421 to be between about 50 to about 100 degrees Celsius. In some embodiments, the heater element 421 may be an open break heater. In some embodiments, the heater element 421 may comprise a no break heater, such as an annular element, thereby facilitating uniform plasma formation within the process chamber 104.

During operation, a substrate 414 (such as a semiconductor wafer or other substrate suitable for plasma processing) may be placed on the pedestal 416 and process gases may be supplied from a gas panel 438 through entry ports 426 to form a gaseous mixture 450 within the process chamber 104. The gaseous mixture 450 may be ignited into a plasma 455 in the process chamber 104 by applying power from the plasma source 418 to the first and second RF coils 110, 112 and optionally, the one or more electrodes (not shown). In some embodiments, power from the bias source 422 may be also provided to the pedestal 416. The pressure within the interior of the chamber 104 may be controlled using a throttle valve 427 and a vacuum pump 436. The temperature of the chamber wall 430 may be controlled using liquid-containing conduits (not shown) that run through the wall 430.

The temperature of the wafer 414 may be controlled by stabilizing a temperature of the support pedestal 416. In one embodiment, helium gas from a gas source 448 may be provided via a gas conduit 449 to channels defined between the backside of the wafer 414 and grooves (not shown) disposed in the pedestal surface. The helium gas is used to facilitate heat transfer between the pedestal 416 and the wafer 414. During processing, the pedestal 416 may be heated by a resistive heater (not shown) within the pedestal to a steady state temperature and the helium gas may facilitate uniform heating of the wafer 414. Using such thermal control, the wafer 414 may illustratively be maintained at a temperature of between 0 and 500 degrees Celsius.

The controller 440 comprises a central processing unit (CPU) 444, a memory 442, and support circuits 446 for the CPU 444 and facilitates control of the components of the reactor 400 and, as such, of methods of forming a plasma, such as discussed herein. The controller 440 may be one of any form of general-purpose computer processor that can be used in an industrial setting for controlling various chambers and sub-processors. The memory, or computer-readable medium, 442 of the CPU 444 may be one or more of readily available memory such as random access memory (RAM), read only memory (ROM), floppy disk, hard disk, or any other form of digital storage, local or remote. The support circuits 446 are coupled to the CPU 444 for supporting the processor in a conventional manner. These circuits include cache, power supplies, clock circuits, input/output circuitry and subsystems, and the like. The inventive method may be stored in the memory 442 as software routine that may be executed or invoked to control the operation of the reactor 400 in the manner described above. The software routine may also be stored and/or executed by a second CPU (not shown) that is remotely located from the hardware being controlled by the CPU 444.

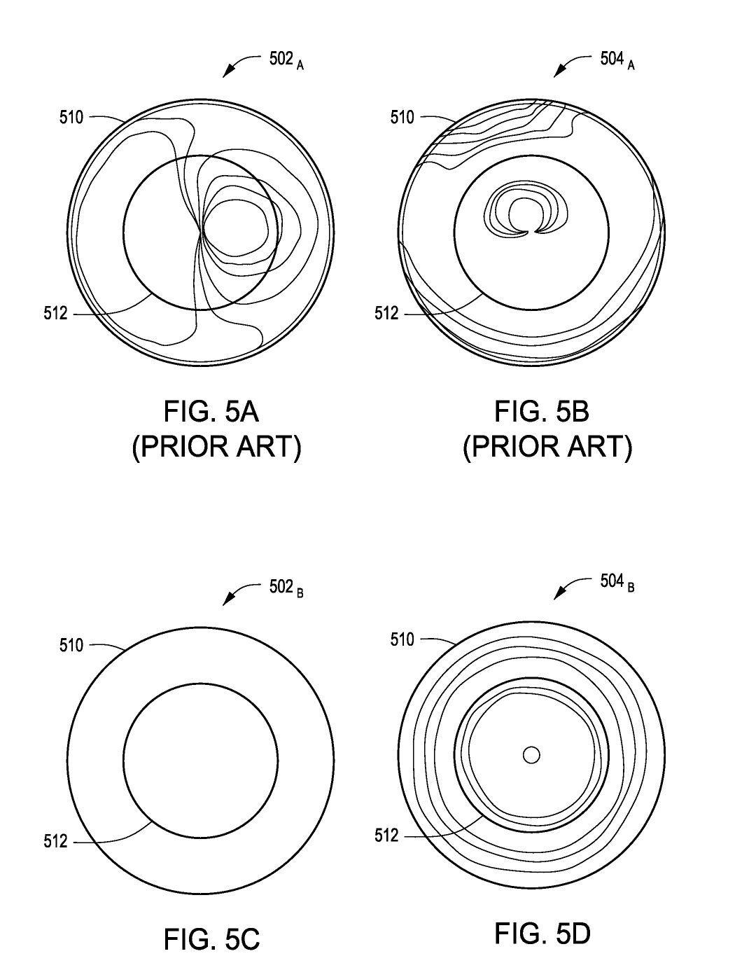

FIGS. 5A-D illustratively depict graphs of electric fields generated using conventional apparatus and an embodiment of the inventive apparatus disclosed herein. These graphs illustratively depict data from actual tests and observations performed by the inventors. FIGS. 5A and 5B respectively depict the radial and azimuthal components of an electric field distribution in a plasma utilizing a conventional RF feed. FIG. 5A depicts a graph 502_{A} of the radial component of the electric field in a process chamber 510. An outline of a substrate 512 is provided for reference. FIG. 5B depicts a graph 504_{A} of the azimuthal component of the electric field in the process chamber 510. As can be seen from the graphs, the electric field distribution in the plasma is not symmetric due to the asymmetric interference of magnetic fields generated by the coil current and asymmetric RF feed wire current.

In contrast, FIGS. 5C and 5D respectively depict the radial and azimuthal components of an electric field distribution in a plasma utilizing embodiments of the inventive RF feed apparatus disclosed herein. FIG. 5C depicts a graph 502_{B} of the radial component of the electric field in the process chamber 510. FIG. 5D depicts a graph 504₈ of the azimuthal component of the electric field in the process chamber 510. As can be seen from the graphs, the electric field distribution in the plasma is greatly improved and substantially or nearly symmetric.

Thus, apparatus for plasma processing have been provided herein. In some embodiments, the inventive apparatus includes an RF feed structure for coupling RF power to inductive RF coils. The inventive RF feed structure advantageously reduces magnetic field asymmetries proximate the inductive RF coils such that a electric field generated by the RF coils is symmetric and accordingly facilitates the formation of a plasma having a symmetric electric field distribution.

While the foregoing is directed to embodiments of the present invention, other and further embodiments of the invention may be devised without departing from the basic scope thereof.

1. An RF feed structure, comprising:
a first RF feed having a first end configured to couple RF power to a plurality of symmetrically arranged stacked first RF coil elements and a second end opposite the first end and configured to receive RF power; and
a second RF feed coaxially disposed about the first RF feed and electrically insulated therefrom, the second RF feed having a first end configured to couple RF power to a plurality of symmetrically arranged stacked second RF coil elements coaxially disposed with respect to the first RF coil elements and a second end opposite the first end and configured to receive RF power.

2. The RF feed structure of claim 1, wherein the first and second RF feeds are coaxially disposed about a central axis and are substantially linear.

3. The RF feed structure of claim 1, wherein:
the first RF feed further comprises a plurality of first terminals disposed symmetrically about the first RF feed and proximate the first end thereof, each first terminal for coupling the first RF feed to a first coil element; and
the second RF feed further comprises a plurality of second terminals disposed symmetrically about the second RF feed and proximate the first end thereof, each second terminal for coupling the second RF feed to a second coil element.

4. The RF feed structure of claim 3, wherein the first RF feed further comprises a base coupled to the first end of the first RF feed, the base having the plurality of first terminals disposed thereon and wherein the second RF feed further comprises an annular flange circumscribing and coupled to the second RF feed proximate the first end thereof, the annular flange having the plurality of second terminals disposed thereon.

5. The RF feed structure of claim 1, wherein the second RF feed further comprises:
a conductive tube coaxially disposed about the first RF feed.

6. The RF feed structure of claim 5, wherein the conductive tube has a length of between about 2 to about 8 inches (about 5 to about 20 cm).

7. The RF feed structure of claim 1, wherein the second RF feed further comprises:
an annular disk circumscribing and coupled to the second RF feed proximate the second end thereof, the annular disk configured to couple RF power to the second RF feed.

8. The RF feed structure of claim 1, wherein the first and second RF feeds have a length such that a magnetic field formed by flowing RF current through the first and second RF feeds has substantially no effect on the symmetry of an electric field formed by flowing RF current through the first and second RF coil elements.

9. A plasma processing apparatus, comprising:
a first RF coil;
a second RF coil coaxially disposed with respect to the first RF coil;
a first RF feed coupled to the first RF coil to provide RF power thereto; and
a second RF feed coaxially disposed with respect to the first RF feed and electrically insulated therefrom, the second RF feed coupled to the second RF coil to provide RF power thereto.

10. The plasma processing apparatus of claim 9, wherein the second RF feed further comprises:
a conductive tube coaxially disposed about the first RF feed, the conductive tube having a first end proximate the second RF coils and a second end opposite the first end.

11. The plasma processing apparatus of claim 10, wherein the second RF feed further comprises:
an annular disk circumscribing and coupled to the conductive tube proximate the first end thereof, the annular disk configured to couple RF power to the second RF feed.

12. The plasma processing apparatus of claim 9, further comprising:
a match network coupled to the first and second RF feeds, the match network configured to couple RF power thereto; and
a power divider for dividing RF power in a desired power ratio between the first and second RF feeds, the power divider being part of the match network or disposed between the match network output and the RF feed structure.

13. The plasma processing apparatus of claim 12, further comprising:
an RF power supply coupled to the match network to provide RF power to the first and second RF coils.

14. The plasma processing apparatus of claim 9, wherein the first RF coil is an inner coil and the second RF coil is an outer coil.

15. The plasma processing apparatus of claim 9:
wherein the first RF coil further comprises a plurality of symmetrically arranged stacked first RF coil elements and wherein each first RF coil element further comprises a leg extending inwardly therefrom and coupled to the first RF feed; and
wherein the second RF coil further comprises a plurality of symmetrically arranged stacked second RF coil elements each second RF coil element further comprises a leg extending inwardly therefrom and coupled to the second RF feed.

16. The plasma processing apparatus of claim 15, wherein the legs of the first RF feed elements are symmetrically arranged about the first RF feed, and wherein the legs of the second RF feed elements are symmetrically arranged about the second RF feed.

17. The plasma processing apparatus of claim 9, wherein the first RF coil further comprises two symmetrically arranged stacked first RF coil elements each having a leg extending radially inward and coupled to the first RF feed, and the second RF coil further comprises four symmetrically arranged stacked second RF coil elements each having a leg extending radially inward and coupled to the second RF feed.

18. The plasma processing apparatus of claim 17, wherein the first RF coil and the second RF coil are rotated 45 degrees with respect to each other such that the legs of the RF first coil are equidistantly spaced from adjacent legs of the second RF coil.

19. The plasma processing apparatus of claim 9, wherein the first RF coil further comprises four symmetrically arranged stacked first RF coil elements each having a leg extending radially inward and coupled to the first RF feed, and the second RF coil further comprises four symmetrically arranged stacked second RF coil elements each having a leg extending radially inward and coupled to the second RF feed.

20. The plasma processing apparatus of claim 19, wherein the first RF coil and the second RF coil are rotated 45 degrees with respect to each other such that the legs of the RF first coil are equidistantly spaced from adjacent legs of the second RF coil.
